(19) United States
(12) Patent Application Publication
(10) Pub. No.: US 2026/0106890 A1
(43) Pub. Date: Apr. 16, 2026

(54) MALICIOUS LATERAL MOVEMENT DETECTION USING REMOTE SYSTEM PROTOCOLS

(71) Applicant: Armis Security Ltd., Tel Aviv-Yafo (IL)

(72) Inventors: Evgeny LUK-ZILBERMAN, Herzliya (IL); Gil BEN ZVI, Hod Hasharon (IL); Ron SHOHAM, Tel Aviv (IL); Yuval FRIEDLANDER, Petah-Tiqwa (IL)

(73) Assignee: Armis Security Ltd., Tel Aviv-Yafo (IL)

(21) Appl. No.: 19/360,103

(22) Filed: Oct. 16, 2025

Related U.S. Application Data
(63) Continuation of application No. 17/811,699, filed on Jul. 11, 2022, now Pat. No. 12,470,593.

(51) Int. Cl. H04L 9/40

(52) U.S. Cl. CPC H04L 63/145; H04L 63/1416

(57) ABSTRACT

A system and method for malicious lateral movement detection. A method includes identifying atomic tunnels in packets sent between devices; identifying tunnel constructs; determining a potentially malicious atomic tunnel among the atomic tunnels by comparing edges of each of the atomic tunnels to edges of previously observed tunnel constructs; determining a potentially malicious tunnel including the potentially malicious atomic tunnel; and mitigating the potentially malicious tunnel. Each atomic tunnel is a structure representing communications among the devices defined with respect to at least three nodes and at least two edges. Each node represents a respective device, and each edge represents a connection between two of the devices. Each atomic tunnel has two hops, where each hop is a level of communication in which a packet is sent from one device to another device. Each tunnel construct is a structure including at least one of the atomic tunnels.

### TECHNICAL FIELD

The present disclosure relates generally to detecting malicious traffic, and more specifically to detecting malicious traffic in tunnels of remote system protocols.

### BACKGROUND

Remote system protocols such as the Remote Desktop Protocol (RDP) allow a user of one system to connect to and access another computer over one or more networks. For RDP, the user is provided with a graphical user interface (GUI) which allows them to remotely control the other computer and perform actions such as accessing the remote computer's desktop, opening and editing files stored on the remote computer, using applications installed on the remote computer, and the like.

Remote system protocols allow for convenient access to remote computers and the data stored thereon. Remote system protocols may enable tunneling, which is often used benignly by information technology (IT) staff. However, tunneling via remote system protocols introduce can also be exploited by malicious individuals. For example, remote system protocols may be used to send packets over networks even when those packets are not created with respect to protocols supported by those networks. This may allow for unauthorized actions such as bypassing firewalls. Use of remote system protocols therefore exposes the remote system to additional cybersecurity threats.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for malicious lateral movement detection. The method comprises: identifying a plurality of atomic tunnels based on data including packets sent between devices among a plurality of devices, wherein each atomic tunnel is a structure representing communications among the plurality of devices defined with respect to at least three nodes and at least two edges, each node representing a respective device of the plurality of devices, each edge representing a connection between two of the plurality of devices, each atomic tunnel having two hops, wherein each hop is a level of communication in which a packet is sent from one device to another device; identifying a plurality of tunnel constructs, wherein each tunnel construct is a structure including at least one of the plurality of atomic tunnels; determining a potentially malicious atomic tunnel among the plurality of atomic tunnels by comparing the edges of each of the plurality of atomic tunnels to a plurality of edges of a plurality of previously observed tunnel constructs; determining a potentially malicious tunnel, wherein the potentially malicious tunnel includes the potentially malicious atomic tunnel; and performing at least one mitigation action based on the determined potentially malicious tunnel.

Certain embodiments disclosed herein also include a non-transitory computer readable medium having stored thereon causing a processing circuitry to execute a process, the process comprising: identifying a plurality of atomic tunnels based on data including packets sent between devices among a plurality of devices, wherein each atomic tunnel is a structure representing communications among the plurality of devices defined with respect to at least three nodes and at least two edges, each node representing a respective device of the plurality of devices, each edge representing a connection between two of the plurality of devices, each atomic tunnel having two hops, wherein each hop is a level of communication in which a packet is sent from one device to another device; identifying a plurality of tunnel constructs, wherein each tunnel construct is a structure including at least one of the plurality of atomic tunnels; determining a potentially malicious atomic tunnel among the plurality of atomic tunnels by comparing the edges of each of the plurality of atomic tunnels to a plurality of edges of a plurality of previously observed tunnel constructs; determining a potentially malicious tunnel, wherein the potentially malicious tunnel includes the potentially malicious atomic tunnel; and performing at least one mitigation action based on the determined potentially malicious tunnel.

Certain embodiments disclosed herein also include a system for malicious lateral movement detection. The system comprises: a processing circuitry; and a memory, the memory containing instructions that, when executed by the processing circuitry, configure the system to: identify a plurality of atomic tunnels based on data including packets sent between devices among a plurality of devices, wherein each atomic tunnel is a structure representing communications among the plurality of devices defined with respect to at least three nodes and at least two edges, each node representing a respective device of the plurality of devices, each edge representing a connection between two of the plurality of devices, each atomic tunnel having two hops, wherein each hop is a level of communication in which a packet is sent from one device to another device; identify a plurality of tunnel constructs, wherein each tunnel construct is a structure including at least one of the plurality of atomic tunnels; determine a potentially malicious atomic tunnel among the plurality of atomic tunnels by comparing the edges of each of the plurality of atomic tunnels to a plurality of edges of a plurality of previously observed tunnel constructs; determine a potentially malicious tunnel, wherein the potentially malicious tunnel includes the potentially malicious atomic tunnel; and perform at least one mitigation action based on the determined potentially malicious tunnel.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIGS. 2A-B are tunnel diagrams showing example simple tunnel structures which may be realized via remote system protocols utilized to describe various disclosed embodiments.

FIG. 3 is a flowchart illustrating a method for detecting malicious lateral movement using remote system protocols according to an embodiment.

FIG. 4 is a flowchart illustrating a method for identifying potentially malicious tunnels according to an embodiment.

FIG. 5 is a flowchart illustrating a method for detecting malicious tunnels according to an embodiment.

FIG. 6 is a schematic diagram of a malicious lateral movement detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for detecting malicious lateral movement using remote system protocols. The disclosed embodiments provide techniques for detecting abnormal tunnels realized via remote system protocols, which can potentially lead to network hacking and data breaches. These abnormal tunnels may be further analyzed to determine whether they are malicious. Traffic occurring via these malicious tunnels can therefore be detected as malicious lateral movement using remote system protocols.

In an embodiment, potentially malicious tunnels are first identified for further analysis. Tunnels between and among three or more devices communicating using remote system protocols are identified based on edges, where each edge is a connection between two of those devices. For each edge, it is determined whether the respective connection is a statistical outliers as compared to the same connection demonstrated in a train data set. Each tunnel having one or more edges that are each either new edges or statistical outliers is identified as a potentially malicious tunnel.

Once potentially malicious tunnels have been identified, they are further analyzed in order to determine whether each potentially malicious tunnel represents a cybersecurity threat by allowing malicious lateral movement. To this end, all tunnels in the train data set are classified with respect to isomorphism, i.e., such that the tunnels are classified into classes with other tunnels having the same structure. Such a structure may be a graph structure characterizing the work style for the tunnel. The identified potentially malicious tunnels are compared to the isomorphic classes, and may be subjected to further analysis depending on whether and which classes those potentially malicious tunnels match. Based on the comparison and any subsequent analysis, it is determined whether to detect those potentially malicious tunnels as malicious tunnels, an alert level to be used for alerting on each malicious tunnel, or both.

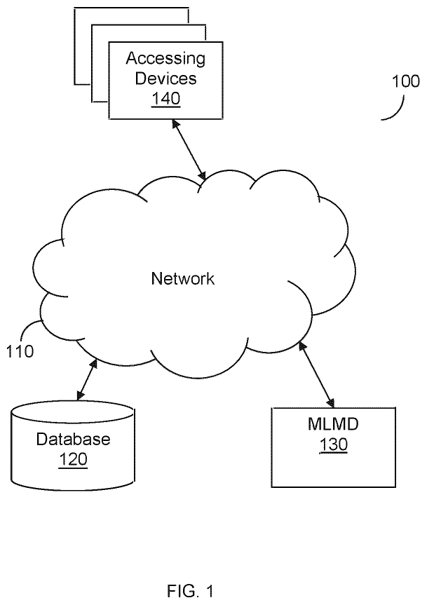

FIG. 1 shows an example network diagram 100 utilized to describe the various disclosed embodiments. In the example network diagram 100, a database 120, a malicious lateral movement detector (MLMD) 130, a plurality of devices 140 (hereinafter referred to individually as a device 140 and collectively as devices 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The database 120 may store data related to connections between and among the devices 140. Such data indicates connections between different devices among the devices 140. The malicious lateral movement detector 130 is configured to detect malicious tunnels as described herein. To this end, the malicious lateral movement detector 130 is configured to analyze the data related to connections between and among the devices 140 in order to identify tunnels and determine whether those tunnels are malicious. The malicious lateral movement detector 130 may further be configured to perform mitigation actions related to malicious tunnels formed via connections between and among the accessing devices 140 such as, but not limited to, generating alerts, severing connections between the accessing devices 140, and the like.

Each of the devices 140 may be, but is not limited to, a personal computer (e.g., a desktop computer), a laptop, a tablet computer, a smartphone, a wearable computing device, or any other device capable of connecting to another device over one or more networks. The devices 140 include one or more remotely accessed devices which are accessed via one or more other devices among the devices 140 using one or more remote system protocols such as, but not limited to, the Remote Desktop Protocol (RDP). One or more of the devices 140 may act as tunneling devices which allow for establishing tunnels among 3 or more devices as described herein by being connected to each of two other devices.

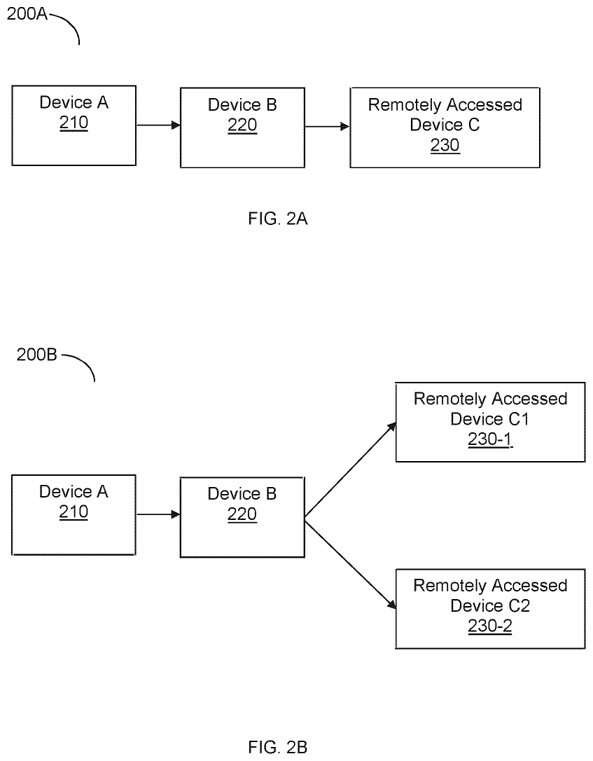

FIGS. 2A-B are tunnel diagrams showing example simple tunnel structures which may be realized via remote system protocols utilized to describe various disclosed embodiments.

In FIG. 2A, a first kind of simple tunnel 200A is shown. A simple tunnel is an atomic structure of a tunnel including two hops which can, in combination with other simple tunnels, form a more complex tunnel structure. The simple tunnel 200A includes a device A 210 connected to a device B 220, which in turn is connected to a remotely accessed device C 230. In FIG. 2A, the device A 210 accesses the remotely accessed device C 230 via the device B 220. Accordingly, the device B 220 acts as a tunneling device by which access between the accessing device A 210 and the remotely accessed device C 230 is realized.

In FIG. 2B, a second kind of simple tunnel 200B is shown. The simple tunnel 200B includes a device A 210 connected to a device B 220, which in turn is connected to two remotely accessed devices C1 230-1 and C2 230-2.

Both of the simple tunnels 200A and 200B are atomic structures including two hops among devices, where a packet being tunneled from device A 210 to a remotely accessed device (i.e., C230, C1 230-1, or C2 230-2) passes through two connections (i.e., a connection from device A 210 to device B 220 and a connection from device B 220 to a remotely accessed device). In other words, for each hop in a tunnel, a packet being sent through the tunnel passes through a connection between a first device and a second device. A simple tunnel therefore includes two hops such that a packet being sent through the simple tunnel passes between two such connections, regardless of whether different packets ultimately are sent to the same remotely accessed device.

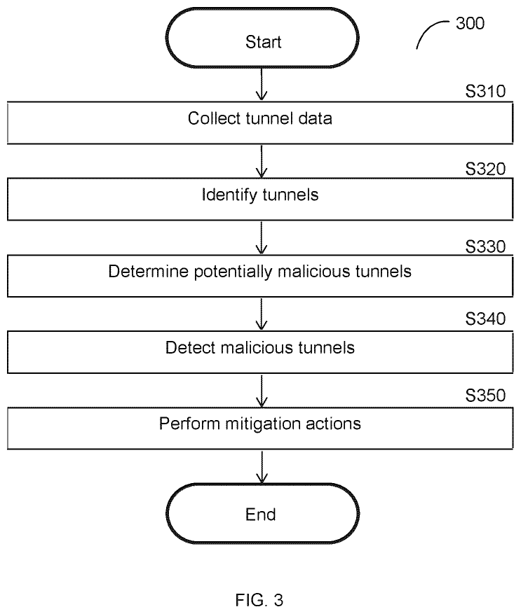

FIG. 3 is a flowchart 300 illustrating a method for detecting malicious lateral movement using remote system protocols according to an embodiment. In an embodiment, the method is performed by the malicious lateral movement detector 130, FIG. 1.

At S310, tunnel data is collected. The tunnel data includes data indicating connections between devices which can therefore be used to identify tunnels formed through multiple such connections.

In some embodiments, the tunnel data is collected over two phases: a train phase, and a test phase that follows the train phase. As a non-limiting example, the train phase may occur during a period of 14 days in which remote desktop protocol (RDP) Internet protocol (IP) session tunnel data is collected and the test phase may occur during a period of 1 day in which RDP IP session tunnel data is collected which takes place after the 14 day period of the train phase. The data collected during the train phase may be used as points of comparison for determining statistical outliers, establishing tunnel classes, and the like.

At S320, tunnels are identified using the collected tunnel data. Each of the tunnels is identified with respect to connections between devices including at least two hops, where in each hop a packet is passed from one device to another. Each tunnel may include one or more simple tunnels each including two hops. Each tunnel is defined using multiple nodes and multiple edges. In an embodiment, each node represents a device, and each edge represents a connection between two nodes (i.e., between two devices).

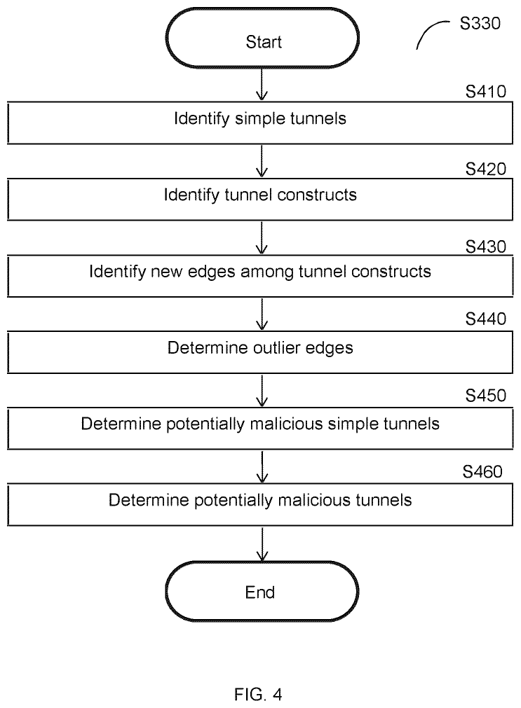

At S330, potentially malicious tunnels among the identified tunnels are determined. In an embodiment, each potentially malicious tunnel includes one or more new edges, one or more outlier edges, or both. Each new edge is new as compared to a baseline. Each outlier edge is a statistical outlier as compared to tunnel data of a baseline tunnel data set. Such a baseline tunnel data set may include, for examples, tunnels represented in tunnel data of a train data set. An example method for determining potentially malicious tunnels is described further below with respect to FIG. 4.

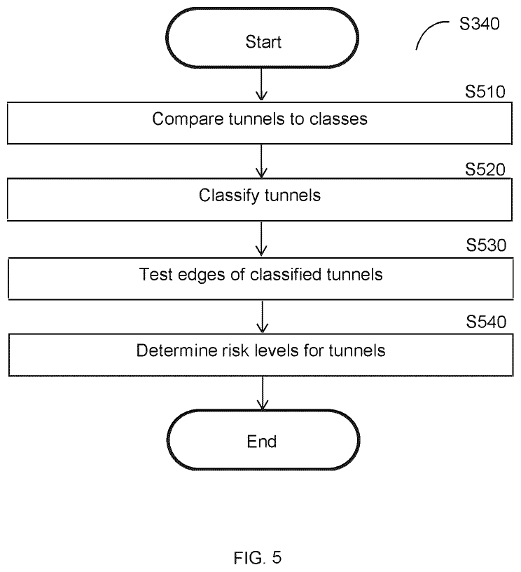

At S340, malicious tunnels are detected from among the potentially malicious tunnels. In an embodiment, S340 includes classifying at least some of the potentially malicious tunnels into one or more isomorphic graph classes, and may further include analyzing a first edge of any potentially malicious tunnels classified into one of the classes as compared to first edges of a baseline tunnel data set. An example method for detecting malicious tunnels is described further below with respect to FIG. 5.

At optional S350, one or more mitigation actions are performed with respect to the detected malicious tunnels. The mitigation actions may include, but are not limited to, generating alerts, controlling connections between devices (e.g., severing connections in order to effectively remove tunnels), both, and the like. The alerts may be generated with respect to any detected malicious tunnels, and may further include risk levels determined as discussed further below.

FIG. 4 is a flowchart S330 illustrating a method for identifying potentially malicious tunnels according to an embodiment.

At S410, simple tunnels are identified within tunnel data. In an embodiment, S410 includes applying simple tunnel identification rules which define criteria for identifying simply tunnels with respect to connections between devices and, more specifically, packets sent between devices included among the tunnel data. To this end, the tunnel data includes at least packets sent between devices. Further, in an embodiment, S410 may include analyzing the packets sent between devices in order to determine connection times, amount of data sent as traffic between devices, both, and the like.

A simple tunnel is defined with respect to at least 3 distinct devices A, B, and C. In an embodiment, a simple tunnel including devices A, B, and C is identified only if communications among devices A, B, and C meet the following criteria. A first criteria is that A connects to B and B connects to C. A second criteria is that connection time for a first hop (e.g., a hop including a connection between A and B) contains a connection time for a second hop (e.g., a hop including a connection between B and C). A third criteria is that an amount of bytes sent in the first hop (i.e., from A to B) contains the amount of bytes sent in the second hop (i.e., from B to C). A fourth criteria is that the traffic amount of bytes sent from B to A contains the amount of bytes sent from C to B. It should be noted that, in some implementations, only some of these criteria may be utilized for identifying simple tunnels (e.g., the first two criteria or the first three criteria).

The simple tunnels are atomic tunnel structures, with each simple tunnel containing two hops. As noted above, a hop is a level of communication in which a packet sent by one device is received by another device. A simple tunnel, also referred to as an atomic tunnel, has two hops such that packets traveling through that simple tunnel travel from a first device to a second device, and then from the second device to the third device. As discussed above with respect to FIG. 2B, each hop may include multiple potential starting and/or destination devices, for example, a destination device C1 and a destination device C2. A simple tunnel has two hops such that a packet traveling through the simple tunnel passes through 3 devices total (i.e., sent by a first device to a second device, then sent by a second device to a third device).

As noted above, in some embodiments, the tunnel data may be included in test and train sets. To this end, S410 may include identifying all simple tunnels in both the test and train sets.

At S420, tunnel constructs are identified. Each complex tunnel is a construct made up of one or more simple tunnels. By identifying all constructs including simple tunnels, all tunnels can be identified regardless of whether they are simple atomic structures or more complex structures including multiple atomic structures.

At S430, new edges among the tunnel constructs are identified. The edges are connections between devices included in the tunnel constructs, and new edges are connections between two devices for which a connection between the two devices was not previously observed (e.g., in previously analyzed tunnel data). For example, new edges may be edges that are observed in the test set but which were not observed in the train set. To this end, S430 may include identifying each edge in each tunnel identified in each of the train and test sets, and comparing between the identified edges to determine if any edges identified in the test set are not identified in the train set.

As a non-limiting example discussed with respect to FIGS. 2A and 2B, assume that remotely accessed device C 230 as depicted in FIG. 2A is the same device as remotely accessed device C1 230-1 depicted in FIG. 2B. The simple tunnel 200A including connections A->B and B->C1 is observed in the tunnel data of the train set. In the test set, the simple tunnel 200B including connections A->B, B->C1, and B->C2 is observed. The connection B->C2 is new as compared to the train set, and therefore an edge representing that connection is identified as a new edge.

At S440, outlier edges are determined. To this end, S440 includes statistically analyzing session data of one or more edges in order to determine whether they are outliers, for example, as compared to previously observed edges (e.g., edges in a train set). The statistical analysis may be performed with respect to session data such as, but not limited to, time of the beginning of a session for an edge (e.g., an hour in which such a session began), a total session duration of a session in which a packet is sent via the edge (e.g., an entire time of communicating among devices in a given tunnel including the edge), an amount of incoming data sent via the connection represented by the edge, and amount of outgoing data sent via the connection represented by the edge, a combination thereof, and the like. For a tunnel construct including only a single simple tunnel A->B->C, the session duration may include the amount of time in a session including communications A->B as well as B->C.

In an embodiment, S440 includes performing local outlier factor (LOF) detection, probability of multinormal distribution analysis, or both. In a further embodiment, LOF detection is performed when the connection appeared less than a threshold number of times previously (e.g., in all prior available data), and multinormal distribution analysis is performed when the connection appeared at least the threshold number of times previously. As a non-limiting example, LOF may be used when the connection appeared less than 30 times previously and multinormal distribution analysis may be used when the connection appeared 30 or more times previously.

In an embodiment, only tunnel constructs including new edges are analyzed for outlier edges. More specifically, any previously observed (i.e., not new) edges among a tunnel construct having one or more new edges may be analyzed to determine whether those previously observed edges are outliers. Analyzing only tunnel constructs with new edges for outlier edges allows for conserving computing resources as compared to analyzing all tunnel constructs for outlier edges. In this regard it is noted that edge is only likely to be considered an outlier if it is a new edge or otherwise included in a tunnel containing a new edge. Thus, in many implementations, it is not necessary to analyze tunnels lacking new edges for outlier edges.

At S450, potentially malicious simple tunnels are determined based on the new edges and the outlier edges. In an embodiment, each potentially malicious simple tunnel is one of the simple tunnels including an outlier edge. In a further embodiment, each potentially malicious tunnel is one of the simple tunnels for which each edge of the simple tunnel is a new edge or an outlier edge.

As a non-limiting example described with respect to the simple tunnel 200A depicted in FIG. 2A, if each of the edge between device A 210 with device B 220 and the edge between Device B 220 with device C 230 is a new edge or an outlier edge, then the simple tunnel 200A is determined to be a potentially malicious simple tunnel.

At S460, potentially malicious tunnels are determined based on the potentially malicious simple tunnels. In an embodiment, each potentially malicious tunnel is a tunnel construct including one or more potentially malicious simple tunnels.

FIG. 5 is a flowchart S340 illustrating a method for detecting malicious tunnels according to an embodiment.

At S510, tunnels are compared to tunnel classes. More specifically, a structure of each tunnel is compared to a structure associated with each tunnel class. The structure of a tunnel is defined with respect to nodes and edges, where each node represents a respective device and each edge represents a respective connection between two devices. Tunnels having the same structure have the same number of both edges and nodes, and further has the same number of edges per hop.

In an embodiment, the tunnel classes are defined using previously observed tunnels such as, but not limited to, tunnels included in the train set. Moreover, the tunnel classes are defined with respect to graph structure, i.e., a structure of the various connections between devices included among the tunnel. Such a graph structure characterizes the work style of the tunnel in a manner that allows for classifying tunnels with respect to work styles. Moreover, the graph structures serve as isomorphic graphs, thereby allowing for comparing tunnels isomorphically.

As a non-limiting example, for tunnels including only one simple tunnel, the structure depicted in FIG. 2A may be a first class of tunnel and the structure depicted in FIG. 2B may be a second class of tunnel. The simple tunnel 200A has three nodes and two edges, with one edge in each hop. The simple tunnel 200B has four nodes and three edges, with one edge in the first hop (A->B) and two edges in the second hop (B->C1 and B->C2).

At S520, the tunnels are classified based on the comparison. In an embodiment, each tunnel whose structure matches the structure associated with one of the tunnel classes is classified into that tunnel class. In a further embodiment, if none of the tunnel class structures match the structure of a given tunnel, the tunnel may be detected as malicious due to abnormality.

At S530, edges of the classified tunnels are tested. That is, for each tunnel that was successfully classified (and was not identified as unclassified), edges of that tunnel are analyzed. The results of the testing may be used, for example, in order to determine whether to generate an alert with respect to each tested tunnel, a risk level for each alert to be generated, both, and the like.

In an embodiment, for each classified tunnel including 3 or 4 nodes (i.e., 3 or 4 devices), a first edge of the tunnel is tested against all first edges of known tunnels having the same tunnel class in order to determine whether the tested first edge is an outlier as compared to the known first edges. The first edge is an edge among the first hop of the tunnel, i.e., an edge between the first device represented in the tunnel and the second device represented in the tunnel when the tunnel is arranged from origin of packets to potential destinations of packets (i.e., where final destinations are remotely accessed systems). As a non-limiting example, the first edge for the simple tunnel shown in FIG. 2A is the edge between device A 210 with device B 220. Whether the first edge is an outlier as compared to other first edges of tunnels in the same classification may be determined, for example, using one or more of the processes discussed above with respect to S440.

In this regard, it is noted that a tunnel having only 3 or 4 nodes representing connected devices has a relatively small number of connections such that only testing the first edge may be sufficient to accurately determine whether to generate an alert for that tunnel, i.e., if the first edge is an outlier for a tunnel having only 3 or 4 nodes, it has been identified that the tunnel presents enough risk to warrant generating an alert. The reason for this is that the work style of a tunnel including only 3 or 4 nodes is too common such that only having a few outliers may be enough to declare an alert, and the difference between the first edge (which is typically the most essential part of the work style for a given tunnel) and other first edges of previously observed tunnels of the same class is sufficient information to determine whether to declare an alert for a potentially malicious tunnel.

At S540, risk levels are determined for the tunnels based on the testing and identification of unclassified tunnels. In an embodiment, the risk level for each tunnel is determined based on a number of devices involved in the tunnel (e.g., a number of devices represented by nodes of the tunnel), a number of potentially malicious simple tunnels in the tunnel, or both. In a further embodiment, the risk level for each tunnel may be determined based on these numbers for the tunnel as compared to respective numbers of devices and/or potentially malicious simple tunnels for previously observed tunnels (e.g., tunnels in the train set). In an example implementation, the risk level may be determined as low, medium, or high for any tunnels for which alerts are to be generated.

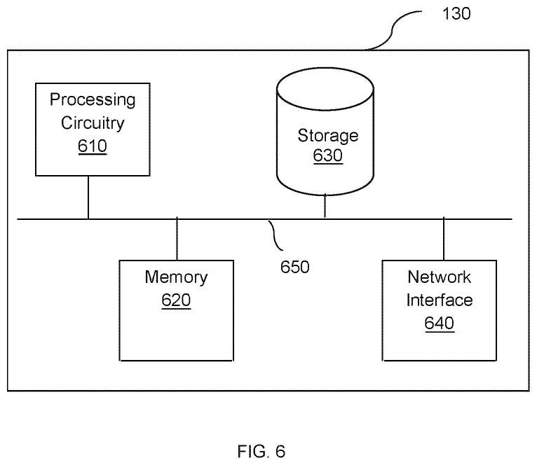

FIG. 6 is an example schematic diagram of a malicious lateral movement detector 130 according to an embodiment. The malicious lateral movement detector 130 includes a processing circuitry 610 coupled to a memory 620, a storage 630, and a network interface 640. In an embodiment, the components of the malicious lateral movement detector 130 may be communicatively connected via a bus 650.

The processing circuitry 610 may be realized as one or more hardware logic components and circuits. For example, and without limitation, illustrative types of hardware logic components that can be used include field programmable gate arrays (FPGAS), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the malicious lateral movement detector 130 to communicate with, for example, the database 120, the accessing devices 140, the remotely accessed device, a combination thereof, and the like.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. (canceled)

2. A method for malicious lateral movement detection, comprising:
identifying a plurality of atomic tunnels representing communications among a plurality of devices, wherein an atomic tunnel is identified by one or more nodes and edges, and wherein each atomic tunnel has two hops, wherein each hop is a level of communication in which a packet is sent from one device to another device, determining a potentially malicious atomic tunnel among the plurality of atomic tunnels by comparing the edges of each of the plurality of atomic tunnels to a plurality of edges of a plurality of previously observed tunnel constructs;
determining a potentially malicious tunnel comprising the potentially malicious atomic tunnel, wherein determining the potentially malicious tunnel comprises:
determining, among a plurality of classifications, a classification of each the plurality of previously observed tunnel constructs, wherein each classification corresponds to an associated structure;
isomorphically comparing a tunnel structure of the potentially malicious atomic tunnel to associated structures of each classification of the plurality of classifications; and
matching the tunnel structure with one of the associated structures to determine the potentially malicious tunnel; and
performing at least one mitigation action based on the potentially malicious tunnel.

3. The method of claim 2, wherein at least one device of the plurality of devices comprises a remotely accessed device accessed by one or more other devices of the plurality of devices using one or more remote system protocols.

4. The method of claim 3, wherein the method further comprises identifying a plurality of tunnel constructs, wherein each tunnel construct is a structure including at least one of the plurality of atomic tunnels.

5. The method of claim 3, wherein the atomic tunnel is defined with respect to at least three nodes and at least two edges, each node representing a respective device of the plurality of devices, each edge representing a connection between two of the plurality of devices, and wherein the potentially malicious atomic tunnel is one of the plurality of atomic tunnels for which at least one of the at least two edges of the potentially malicious atomic tunnel is an outlier edge as compared to the edges of the plurality of previously observed tunnel constructs.

6. The method of claim 3, wherein each edge of the potentially malicious atomic tunnel is either a new edge or an outlier edge as compared to the edges of the plurality of previously observed tunnel constructs, wherein a new edge is an edge that was not included among the plurality of previously observed tunnel constructs.

7. The method of claim 6, further comprising:
analyzing session data for the edges of at least one tunnel construct of a plurality of tunnel constructs in order to determine whether each edge of the at least one tunnel construct is an outlier edge as compared to the edges of the plurality of previously observed tunnel constructs.

8. The method of claim 7, wherein the session data includes at least one of: time of beginning of session, total session duration, amount of incoming data, and amount of outgoing data.

9. The method of claim 2, further comprising:
comparing a structure of a potentially malicious tunnel construct to a structure associated with each of a plurality of tunnel classes in order to determine a classification for the potentially malicious tunnel, wherein each of the plurality of tunnel classes is defined based on a respective portion of the plurality of previously observed tunnel constructs;
testing a first edge of the potentially malicious tunnel construct in order to determine whether the first edge is an outlier edge as compared to a first edge of each of at least one matching class tunnel construct of the plurality of previously observed tunnel constructs, wherein each of the at least one matching class tunnel construct has a same classification as the potentially malicious tunnel construct; and
detecting the potentially malicious tunnel as a malicious tunnel when the first edge is an outlier edge as compared to the first edge of each of the at least one matching class tunnel construct.

10. The method of claim 2, wherein, for each atomic tunnel, a first connection time of a first hop of the atomic tunnel includes a second connection time of a second hop of the atomic tunnel.

11. The method of claim 2, wherein, for each atomic tunnel, an amount of data sent in a first hop of the atomic tunnel includes an amount of data sent in a second hop of the atomic tunnel.

12. The method of claim 2, wherein performing the at least one mitigation action includes generating an alert including a risk level, wherein the risk level is determined based on at least one of: a number of devices represented by nodes of the potentially malicious tunnel, and a number of potentially malicious atomic tunnels included in the potentially malicious tunnel.

13. A non-transitory computer readable medium having stored thereon instructions for causing a processing circuitry to execute a process, the process comprising:
identifying a plurality of atomic tunnels representing communications among a plurality of devices, wherein an atomic tunnel is identified by one or more nodes and edges, and wherein each atomic tunnel has two hops, wherein each hop is a level of communication in which a packet is sent from one device to another device, determining a potentially malicious atomic tunnel among the plurality of atomic tunnels by comparing the edges of each of the plurality of atomic tunnels to a plurality of edges of a plurality of previously observed tunnel constructs;
determining a potentially malicious tunnel comprising the potentially malicious atomic tunnel, wherein determining the potentially malicious tunnel comprises:
determining, among a plurality of classifications, a classification of each the plurality of previously observed tunnel constructs, wherein each classification corresponds to an associated structure;
isomorphically comparing a tunnel structure of the potentially malicious atomic tunnel to associated structures of each classification of the plurality of classifications; and
matching the tunnel structure with one of the associated structures to determine the potentially malicious tunnel; and
performing at least one mitigation action based on the potentially malicious tunnel.

14. A system for malicious lateral movement detection, comprising:
a processing circuitry; and
a memory, the memory containing instructions that, when executed by the processing circuitry, configure the system to:
identify a plurality of atomic tunnels representing communications among a plurality of devices, wherein an atomic tunnel is identified by one or more nodes and edges, and wherein each atomic tunnel has two hops, wherein each hop is a level of communication in which a packet is sent from one device to another device, determining a potentially malicious atomic tunnel among the plurality of atomic tunnels by comparing the edges of each of the plurality of atomic tunnels to a plurality of edges of a plurality of previously observed tunnel constructs;
determine a potentially malicious tunnel comprising the potentially malicious atomic tunnel, wherein determining the potentially malicious tunnel comprises:
determining, among a plurality of classifications, a classification of each the plurality of previously observed tunnel constructs, wherein each classification corresponds to an associated structure;
isomorphically comparing a tunnel structure of the potentially malicious atomic tunnel to associated structures of each classification of the plurality of classifications; and
matching the tunnel structure with one of the associated structures to determine the potentially malicious tunnel; and
perform at least one mitigation action based on the potentially malicious tunnel.

15. The system of claim 14, wherein at least one device of the plurality of devices comprises a remotely accessed device accessed by one or more other devices of the plurality of devices using one or more remote system protocols.

16. The system of claim 14, wherein the system is further configured to: identifying a plurality of tunnel constructs, wherein each tunnel construct is a structure including at least one of the plurality of atomic tunnels.

17. The system of claim 15, wherein the atomic tunnel is defined with respect to at least three nodes and at least two edges, each node representing a respective device of the plurality of devices, each edge representing a connection between two of the plurality of devices, and wherein the potentially malicious atomic tunnel is one of the plurality of atomic tunnels for which at least one of the at least two edges of the potentially malicious atomic tunnel is an outlier edge as compared to the edges of the plurality of previously observed tunnel constructs.

18. The system of claim 15, wherein each edge of the potentially malicious atomic tunnel is either a new edge or an outlier edge as compared to the edges of the plurality of previously observed tunnel constructs, wherein a new edge is an edge that was not included among the plurality of previously observed tunnel constructs.

19. The system of claim 18, wherein the system is further configured to:
analyzing session data for the edges of at least one tunnel construct of a plurality of tunnel constructs in order to determine whether each edge of the at least one tunnel construct is an outlier edge as compared to the edges of the plurality of previously observed tunnel constructs.

20. The system of claim 19, wherein the session data includes at least one of: time of beginning of session, total session duration, amount of incoming data, and amount of outgoing data.

21. The system of claim 14, wherein, for each atomic tunnel, a first connection time of a first hop of the atomic tunnel includes a second connection time of a second hop of the atomic tunnel.
